(19) United States
(12) Patent Application Publication
(10) Pub. No.: US 2013/0337141 A1
(43) Pub. Date: Dec. 19, 2013

(54) SPREADABLE GELS

(71) Applicants: Kristina Smit-Boer, Stadskanaal (NL); Heine Roelf Meima, Borgercompagnie (NL); Pieter Lykle Buwalda, Groningen (NL); Zhenghong Chen, Groningen (NL)

(72) Inventors: Kristina Smit-Boer, Stadskanaal (NL); Heine Roelf Meima, Borgercompagnie (NL); Pieter Lykle Buwalda, Groningen (NL); Zhenghong Chen, Groningen (NL)

(73) Assignee: DSM IP ASSETS B.V., Heerlen (NL)

(21) Appl. No.: 13/990,751

(22) PCT Filed: Dec. 12, 2011
(86) PCT No.: PCT/EP11/72407

§ 371 Date: Sep. 4, 2013

(30) Foreign Application Priority Data
Dec. 13, 2010 (EP) 10194736.4

(51) Int. Cl. A23L 1/0522

(52) U.S. Cl. CPC A23L 1/05223
USPC 426/578

(57) ABSTRACT

The present invention provides a spreadable gel which comprises 0.5 to 8 wt % of an amylomaltase treated starch, 0.5 to 8 wt % of a waxy starch, water and optionally a basic ingredient such as fruit, vegetable or soy.

### FIELD OF THE INVENTION

This invention relates to the preparation of spreadable gels using starch products without using other hydrocolloids or emulsifiers.

### BACKGROUND OF THE INVENTION

Spreadable fruit gels are well known. Jams, jellies, preparations for yogurt formulations, spreads, sweet preservatives and sauces are just a few examples. The common denominator of these products is that they are weak gels that more or less reform on breaking the gel. Usually, pectins are used to make fruit gels. The pectin can be derived from the fruit from which the preparation is made or it can be added separately depending on the fruit and the preparation process. In modern process industry to avoid time consuming heating and acidulation usually pectin is added leading to increased cost on ingredients but faster processes. In cold processes low methoxyl (LM) pectin is added (see for example M.J.A. Schroder in “Food Quality and Consumer Value, Delivering Food that Satisfies” Springer Verlag, Berlin-Heidelberg-New York, 2003 page 170) and the gel is prepared by adding a calcium source. Working with pectins is by no means easy; pectins are expensive and difficult to dissolve. Moreover, once prepared it is not easy to rework rejected product by redissolution. Other spreadable gels include peanut butter, but also fillings, stuffings, etc.

Another example of spreadable gel is found in soups, ready meals and filling. Such gels are used for the fillings in the preparation of soup dumplings, the sauces for ready-to-eat meals and frozen meals, such as chilled, frozen and retorted pouch foods, such as, pasta, Asian noodles and rice and soups. Traditionally, gelatin and animal fats are the necessary ingredients for soup dumplings fillings. The liquid “soup or juice” is solidified by gelatin or fat during soup dumpling preparation. After cooking, the solid gelatin or fat becomes liquid “soup or juice” for consumption. However, the gelatin or fat makes the soup or juice too thick or fatty. Furthermore, these ingredients are not suitable for. vegetarian foods. In the ready-to-eat meals, frozen meals or retorted pouch foods, the sauces are usually packed in liquid or semi-liquid form in a plastic bag. Such a liquid sauce is not easy for packaging, storing and opening the pack before consumption, and also increases the use of plastic materials and the disposal of (undegradable) waste as well.

### SUMMARY OF THE INVENTION

The present invention discloses a “gel like sauce” which may be made by a blend of an amylomaltase treated starch and waxy starch such as a (degraded) amylopectin starch. The sauce is a cuttable gel which can be cut in any shape. Such “gel like sauce” can be directly put on the top of the main meals, inside or next to meals or mix with the meals without syneresis. When heated, such as in a microwave oven, the “gel liked sauce” becomes liquid and can be used as liquid sauce for preparing the meals.

One embodiment of the invention relates to a gel which comprises 0.2 to 12 wt %, for instance 0.5 to 8 wt %, for instance 1 to 7 wt % of an amylomaltase treated starch, 0.2 to 12 wt %, for instance 0.5 to 8 wt %, for instance 1 to 7 wt % of a waxy starch, water and optionally a basic ingredient such as fruit, vegetable or soy. Advantageously this gel becomes liquid when heated and is cuttable.

The gel of the invention can be made from a mix or kit of parts which comprises 0.5 to 8 wt % of an amylomaltase treated starch, 0.5 to 8 wt % of a waxy starch, water and optionally a basic ingredient such as fruit, vegetable or soy.

The gel of the invention can also be part of a food or food composition which comprises on top, inside or next to the food or food composition the gel of the invention whereby the gel is distinct from the rest of the food.

According to another aspect of to invention a process is disclosed to produce the gel of the invention whereby 0.5 to 8 wt % of an amylomaltase treated starch, 0.5 to 8 wt % of a waxy starch, water and optionally a basic ingredient such as fruit or soy are brought together.

The starches used in the gel of the invention can be mixed before making the gel. Therefore to a further aspect of the invention a composition is disclosed comprising an amylomaltase treated starch and a waxy starch in a weight ratio of amylomaltase treated starch and a waxy starch of between 95/5 and 5/95. Preferably this composition is a powder.

### DETAILED DESCRIPTION OF THE INVENTION

By “gel like sauce” is meant a composition which at room temperature is a gel and when heated becomes a sauce or a viscous liquid, and whereby the gel is a cuttable gel. A “gel like sauce” can for example be savoury or sweet, depending on the basic compound present. The basic compound is the compound that mainly attributes to the taste or smell of the “gel like sauce”.

A “gel” is a solid, jelly-like material, the gel consists for the major part of water and the gel comprises a structurant which prevents yielding under its own weight.

By “waxy starch” or “amylopectin starch” is meant a starch that contains mainly amylopectin and no or low amounts (less than 3 wt %, typically 1% or less) of amylose starch.

By “spread” is meant a food that is spread with a knife onto bread, crackers, or other bread products. Spreads are added to bread products to provide flavor and texture, and are an integral part of the dish, i.e., they should be distinguished from condiments, which are optional additions. Spreads should also be distinguished from dips, which do not employ a knife in applying it to crackers or chips.

As such, “spread” has a functional definition, which means that the same food can be categorized as a spread, a “condiment”, or an “ingredient” under different circumstances. A good example of this would be butter, which could appear on a hamburger as a condiment, on buttered toast as a spread, and in mashed potatoes as an ingredient.

Common spreads include cheeses, creams, and butters (spreads made from milk; though the term butter is broadly applied to many spreads); and jams and jellies (spreads made from fruit). Spreads are also made from vegetables (e.g., vegemite, hummus, baba ghanoush, and meats (e.g., pâté, fleischbutter, cretons). Wikipedia is used as source for spread.

By “starch derivative” or “modified starch” is meant a starch that has been modified to allow the starch to function properly under conditions frequently encountered during processing or storage, such as high heat, high shear, low pH, freeze/thaw and cooling. Modifying can be done chemically, physically or otherwise. When a starch is pre-cooked, it can then be used to thicken instantly in cold water. This is referred to as a pregelatinized starch. Otherwise, starch requires heat to thicken, or “gelatinize”.

The present “gel like sauce” does not only make the production and preparation of food or meals easier, but also packaging of the sauce can be avoided which results in cost saving and further protection of the environment. Patent application EP1962619 (A1) describes a soup gelled by starches. However, high starch concentrations are necessary as opposed to the present invention. Moreover, gels based only on this starch are cuttable and brittle instead of mouldable and spreadable.

Surprisingly it has now been found that by a combination of amylomaltase treated starch and waxy starch weak spreadable gels can be prepared, that do not suffer syneresis.

The formation of gels of amylomaltase treated starch in water is well known. Patent EP 0932444 B1 describes the gels in concentration of 3% and higher. Strong, non-clear, brittle gels are formed. These gels are not spreadable or moldable, because they will break and the gel particles will prevail. Patent application WO2009080838 (A2) describes the formation of cutable, clear, somewhat brittle gels in soft sugar confectionery. Here too, the gels are not spreadable and will not reform once disturbed.

In patent application EP1145646 (A1) the formation of brittle reversible gels is described. The gels are formed at relatively high starch concentrations. A further draw back is that the spreadability and mouldability are poor. In patent EP0799837(B1) the formation of gels consisting of an interaction between potato amylopectin and certain emulsifiers is described. It is obvious that in many fruit applications the addition of fatty acid based emulsifiers is undesirable. In the present invention this addition is not necessary. In non-clear gels the addition of such emulsifiers will lead to extra E-numbers on the labeling which is less preferred.

The replacement of pectin in fruit preparation by starch derivatives has been described before. In patent application EP 898 901 A2 the application of low Dextrose Equivalent (DE) maltodextrin is described. A draw back of this method is that the gel is brittle and the dosage is in comparison to pectin very high. The formation of cuttable elastic gels is described in patent application EP 1510527 A1. Although jams are mentioned the characteristic of elastic strong gel is by no means equivalent to any spreadable gel.

In the current invention pectin is replaced at low starch dosage level leading to soft clear gels capable of reform once disturbed. The starch dosage level is preferably less than 16 wt %, more preferably less than 12 wt %, and most preferably less than 10 wt % of starch. In general the gel will contain more than 1 wt %, preferably more than 2 wt %, more preferably more than 3 wt % and most preferably more than 4 wt % of starch. The replacement is achieved, as stated above, by using amylomaltase treated starch in conjuntion with a waxy starch and/or waxy starch derivative, which may or may not be pregelatinized.

The production of amylomaltase treated starch has been described in patent EP 0932444 B1. An amylose containing starch is converted by an α-1-4, α-1-4 glucano transferase (amylomaltase EC 2.4.1.25) to a chain elongated amylopectin. The typical and relevant activity of the amylomaltase is that the enzyme breaks an α-1,4 bond between two glucose units to subsequently make a novel α-1,4 bond. This amylomaltase does not degrade the starch, but reattaches the amylose onto the amylopectin. In the end the amylose is reattached to the amylopectin resulting in the desired product. The product forms thermoreversible gels in low concentrations (typically <10%) in water. The present invention provides a starch composition, comprising, as stated before, an amylomaltase treated starch. Starches suitable for use in a composition according to the invention are for example chosen from maize, wheat, barley, rice, triticale, rice, millet, tapioca, arrow root, banana, potato, sweet potato starches or from high amylose starches like amylomaize, wrinkled pea starch, mung bean starch. High amylose starches may be derived from naturally occurring mutant from cereal starches like high amylose corn, or peas, beans etc. or from genetically modified plant varieties such as potatoes modified to preferentially produce amylose. Alternatively, the amylomaltase treated starches can be derived form a blend of amylose containing starches and amylopectin rich starches like waxy maize, waxy barley, waxy wheat, waxy rice, amylopectin potato, amylopectin tapioca, amylopectin sweet potato or amylopectin banana starch. Amylopectin starches may be derived from plants that selectively produce amylopectin such as waxy cereals or amylose-free potato mutants and/or genetically modified plant varieties such as potatoes and tapioca modified to selectively produce amylopectine.

It is understood that (minor) chemical or physical modifications of the starch are included in the present invention. So the starch in the present gel can be either a starch as such or a starch derivative. The skilled person will understand that in case amylomaltase treated starch is mentioned, the starch is at least treated with an amylomaltase, in case amylomaltase treated is not mentioned in connection to the starch, the starch may be starch or a derivative but is not amylomaltase treated.

An example of the production of amylomaltase treated starch is described in EP0932444 B1. The amylomaltase treated starch can be prepared from suspension of potato starch in water (19-20% w/w). This suspension is jet-cooked at 150-160° C. in order to dissolve the starch. The product is cooled in vacuo to 70° C. Flash cooling is a preferred option. The pH is adjusted to 6.2 using for example 6N H₂SO₄. Then amylomaltase (2 ATU/g starch) is added. The solution is stirred for 2 to 20 hr at 70° C. Then the solution is jetcooked at 130° C. for a short time, for example 1 to 20 seconds and spray dried using for example a model Compact spray dryer (Anhydro, Danmark).

Pregelatinized starch can be prepared according to methods well known to the artisan. Non-exclusive examples thereof are spray drying, spray cooking, drum drying, extrusion, hydrous organic solvents. These techniques can sometimes be used in conjunction with cooking techniques such batch or jet cooking. Virtually all starches can be pregelatinized. For example the starches can be chosen from maize, wheat, barley, rice, triticale, rice, millet, tapioca, arrow root, banana, potato, sweet potato starches or from high amylose starches like amylomaize, wrinkled pea starch, mung bean starch. High amylose starches may be derived from a naturally occurring mutant from cereal starches like high amylose corn, or peas, beans etc. or from genetically modified plant varieties such as potatoes modified to preferentially produce amylose. In a preferred embodiment the starch is chosen from the amylopectin rich starches like waxy maize, waxy barley, waxy wheat, waxy rice, amylopectin potato, amylopectin tapioca, amylopectin sweet potato or amylopectin banana starch. Amylopectin starches may be derived from plants that selectively produce amylopectin such as waxy cereals or amylose-free potato and tapioca mutants and/or genetically modified plant varieties such as potatoes and tapioca modified to selectively produce amylopectin.

Alternatively the pregelatinized starch can be derived from a separation process as described in patent application DE928100 in combination with pregelatinizing techniques.

Waxy potato starch derivatives can be prepared in many ways as is described in O.B. Wurzburg, Modified starches: properties and uses, CRC Press, Boca Raton 1986. In a preferred embodiment the starch is acid degraded as is described in patent EP1272053.

The resulting amylomaltase treated starch and the waxy starch or waxy starch derivative can be blended in order to meet the requirements of the gel.

The invention will now be demonstrated with non-excluding examples.

### Experimental Part

### General

One Amylomaltase unit (ATU) is defined as the amount of amylomaltase which produces 1 μmol of glucose per minute under the assay conditions of the test. Assay:

Amylomaltase is incubated with maltotriose at pH 6.50 and 70 degrees Celsius, releasing glucose from the substrate. The incubation is stopped by adding hydrochloric acid. The amount of released glucose is a measure for the amylomaltase activity and is examined using a glucose test assay (NADH formation) on a Selectra analyzer at a wavelength of 340 nm.

### Acid Degradation of Starch

A 39% (w/w) suspension is prepared of 1 kg of amylopectin potato starch in water. 15 mL of 10 N H2SO4 are added and the temperature is maintained at 45 degrees Celsius for 24 hours. The reaction suspension is filtered and the starch is suspended in water again. This suspension is then neutralized using 4.4% (w/w) NaOH solution. The product is obtained by filtering, washing on the filter and drying.

### EXAMPLES

### Example 1

### Preparation of the Fruit Gel

A blend consisting of 32.4% of sugar, 2.5% of starch, 0.2% of citric acid and 64.9% of fresh strawberries is made in the following way. Mix sugar starch and citric acid. The strawberries are added to the mix. In a stirred and scraped cooker the mix is cooked to the boil for 3 minutes. Then the mixture is cooled to 20 ° C.

Tabel 1 shows the results of several starches which are used in fruit preparations.

TABLE 1
Results of fruit preparations

| | | | | | Spread- |
|---|---|---|---|---|---|
| Product | Texture | Appearance | Syneresis | Clarity | ability |
| Spray cooked | Thin | Glossy | No | medium | Watery |
| waxy potato | | | | | |
| starch A | | | | | |
| Amylomaltase | Jelly | Medium | Yes | low | Crumbly |
| treated | | | | | |
| starch B | | | | | |
| Blend of starch | Short | shiny/glossy | No | high | good/ |
| A and starch B | | | | | smooth |
| (50/50) | | | | | |

* Blends with instant normal potato starch all show low clarity and syneresis Starch A is Eliane ™ EZ 100 and starch B is Etenia ™ 457 both products of AVEBE.

### Example 2

### Solid Mouldable Sauce Preparation

### Materials

Amylomaltase treated potato starch is starch A (Etenia™ 457). Acid degraded waxy potato starch (see above) is Starch C. Soya sauce, salt and sugar are commercial products purchased from the local super market.

### Preparation

All dry ingredients and blended. Then water and soy sauce are added and the solution is cooked to the boil for 3 minutes. The solution is kept in the refrigerator overnight at 4° C.

The variations and results are listed in Table 2.

TABLE 2
Recipe and evaluation of solid mouldable sauce (in weight (grams))

| | Products | | | |
|---|---|---|---|---|
| | | | 2 wt % Starch | 4 wt % Starch |
| | 6 wt % | 6 wt % | A + 4 wt % | A + 2 wt % |
| Ingredient | Starch A (g) | Starch C (g) | Starch C (g) | Starch C (g) |
| Starch A | 12 | — | 4 | 8 |
| Starch C | — | 12 | 8 | 4 |
| Soy sauce | 30 | 30 | 30 | 30 |
| Salt | 10 | 10 | 10 | 10 |
| Sugar | 10 | 10 | 10 | 10 |
| Water | 138 | 138 | 138 | 138 |
| Syneresis | yes | no | no | no |
| Gel | strong and | no | strong | strong and |
| formation | brittle | | | mouldable |

1. A gel which comprises from 0.5 to 8 wt % of an amylomaltase treated starch, from 0.5 to 8 wt % of a waxy starch, water and optionally a basic ingredient optionally comprising fruit, vegetable and/or soy.

2. The gel according to claim 1, which comprises a gel like sauce.

3. The gel according to claim 1, which becomes liquid when heated.

4. The gel according to claim 1, which is cuttable.

5. The gel according to claim 2, which is a spread.

6. A mix or kit of parts which comprises from 0.5 to 8 wt % of an amylomaltase treated starch, from 0.5 to 8 wt % of a waxy starch, water and optionally a basic ingredient optionally comprising fruit, vegetable and/or soy.

7. A food or food composition which comprises on top, inside and/or next to the food or food composition, the gel of claim 1, wherein said gel is distinct from other portions of the food or food composition.

8. A process for producing a gel according to claim 1, comprising bringing together from 0.5 to 8 wt % of an amylomaltase treated starch, from 0.5 to 8 wt % of a waxy starch, water and optionally a basic ingredient optionally comprising fruit and/or soy.

9. A composition comprising an amylomaltase treated starch and a waxy starch in a weight ratio of amylomaltase treated starch to a waxy starch of from 95/5 to 5/95.

10. The composition of claim 9, which is capable of being used to produce a gel.

11. The composition according to claim 9, which comprises a powder.
